(19) United States
(12) Patent Application Publication
(10) Pub. No.: US 2009/0011383 A1
(43) Pub. Date: Jan. 8, 2009

(54) Extrasonic Scaler

(76) Inventor: Tien-Ping Chen, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/772,595

(22) Filed: Jul. 2, 2007

(51) Int. Cl. A61C 17/00

(52) U.S. Cl. 433/143

(57) ABSTRACT

An extrasonic scaler includes a triangulate straight scaler, a leftward bent arc-shaped triangulate scaler, a rightward bent arc-shaped triangulate scaler, a leftward bent distal-hoe semi-triangulate scaler, a rightward bent distal-hoe semi-triangulate scaler, a leftward bent mesial-hoe semi-triangulate scaler, and a rightward bent mesial-hoe semi-triangulate scaler. Thus, the extrasonic scaler is designed according to the tooth pattern of the human body so that the extrasonic scaler can reach the deeper surface of the tooth root from various different directions to remedy the oral and periodontal diseases, thereby enhancing the working efficiency.

### BACKGROUND OF THE INVENTION

1. Field of the Invention

The present invention relates to a medical instrument and, more particularly, to a dental instrument, such as an extrasonic scaler for remnant root canal removal, remedying periodontal diseases, incision and drain for pericorinitis, gingivectomy and gingivoplasty.

2. Description of the Related Art

A conventional periodontal curet can enter the periodontal cell of a human body to clear the calculus deposited on the tooth root surface and can reduce harm to the periodontal soft tissue. A conventional oral irrigator or dental jet can be used to clear the calculus deposited on the tooth root surface more quickly than the periodontal curet. However, the conventional oral irrigator has a conical probe design so that it easily causes an uncomfortable sensation to the patient during the cleaning process. In addition, the conventional oral irrigator easily breaks the normal peripheral tissue. Further, the conventional oral irrigator easily slips during operation and cannot deeply extend into the periodontal cell easily. Further, the conventional oral irrigator cannot replace the traditional elevator.

### BRIEF SUMMARY OF THE INVENTION

In accordance with the present invention, there is provided an extrasonic scaler, comprising a triangulate straight scaler having a root portion and a straight flat face extending from the root portion with a determined included angle defined between the root portion and the straight flat face, a leftward bent arc-shaped triangulate scaler having a root portion and an arc-shaped flat face extending from the root portion and having a front end bent leftward with a determined included angle defined between the arc-shaped flat face and the front end of the arc-shaped flat face, a rightward bent arc-shaped triangulate scaler having a root portion and an arc-shaped flat face extending from the root portion and having a front end bent rightward with a determined included angle defined between the arc-shaped flat face and the front end of the arc-shaped flat face, a leftward bent distal-hoe semi-triangulate scaler having a root portion and an arc-shaped distal-hoe flat face extending from the root portion and having a front end bent leftward with a determined included angle defined between the arc-shaped distal-hoe flat face and the front end of the arc-shaped distal-hoe flat face, a rightward bent distal-hoe semi-triangulate scaler having a root portion and an arc-shaped distal-hoe flat face extending from the root portion and having a front end bent rightward with a determined included angle defined between the arc-shaped distal-hoe flat face and the front end of the arc-shaped distal-hoe flat face, a leftward bent mesial-hoe semi-triangulate scaler having a root portion and an arc-shaped mesial-hoe flat face extending from the root portion with a determined included angle defined between the root portion and the arc-shaped mesial-hoe flat face, and a rightward bent mesial-hoe semi-triangulate scaler having a root portion and an arc-shaped mesial-hoe flat face extending from the root portion with a determined included angle defined between the root portion and the arc-shaped mesial-hoe flat face.

The primary objective of the present invention is to provide an extrasonic scaler that comprises seven scalers so that the extrasonic scaler can be operated easily, quickly and conveniently, can easily enter the tooth root surface located in the deeper periodontal cell, can exactly reach the contact point with the tooth root surface, can remove the broken tooth root and the dead periodontal tissue and can be less harmful to the periodontal soft tissue and alveolar bone to provide a comfortable sensation to the patient, thereby enhancing the versatility of the extrasonic scaler.

Another objective of the present invention is to provide an extrasonic scaler that is helpful to remove the upper and lower calculus of the gums, helpful to the gums shaping, helpful to cutting, incision and drain for gums inflammation, helpful to remove the dead periodontal tissue and the toxins of the tooth root surface, helpful to remnant root canal removal, helpful to replace the traditional elevator to extract the tooth, helpful to reduce harm to the periodontal soft tissue and alveolar bone, helpful to greatly shorten the surgical and treating period and helpful to provide a comfortable sensation to the patient.

A further objective of the present invention is to provide an extrasonic scaler that is designed according to the tooth pattern of the human body so that the extrasonic scaler can reach the deeper surface of the tooth root from various different directions to remedy the oral and periodontal diseases, thereby enhancing the working efficiency.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of an extrasonic scaler in accordance with the preferred embodiment of the present invention.

FIG. 2 is a left view of the extrasonic scaler as shown in FIG. 1.

FIG. 3 is a top view of the extrasonic scaler as shown in FIG. 1.

FIG. 4 is a front view of an extrasonic scaler in accordance with another preferred embodiment of the present invention.

FIG. 5 is a left view of the extrasonic scaler as shown in FIG. 4.

FIG. 6 is a top view of the extrasonic scaler as shown in FIG. 4.

FIG. 7 is a front view of an extrasonic scaler in accordance with another preferred embodiment of the present invention.

FIG. 8 is a right view of the extrasonic scaler as shown in FIG. 7.

FIG. 9 is a top view of the extrasonic scaler as shown in FIG. 7.

FIG. 10 is a front view of an extrasonic scaler in accordance with another preferred embodiment of the present invention.

FIG. 11 is a left view of the extrasonic scaler as shown in FIG. 10.

FIG. 12 is a top view of the extrasonic scaler as shown in FIG. 10.

FIG. 13 is a front view of an extrasonic scaler in accordance with another preferred embodiment of the present invention.

FIG. 14 is a right view of the extrasonic scaler as shown in FIG. 13.

FIG. 15 is a top view of the extrasonic scaler as shown in FIG. 13.

FIG. 16 is a front view of an extrasonic scaler in accordance with another preferred embodiment of the present invention.

FIG. 17 is a left view of the extrasonic scaler as shown in FIG. 16.

FIG. 18 is a top view of the extrasonic scaler as shown in FIG. 16.

FIG. 19 is a front view of an extrasonic scaler in accordance with another preferred embodiment of the present invention.

FIG. 20 is a right view of the extrasonic scaler as shown in FIG. 19.

FIG. 21 is a top view of the extrasonic scaler as shown in FIG. 19.

### DETAILED DESCRIPTION OF THE INVENTION

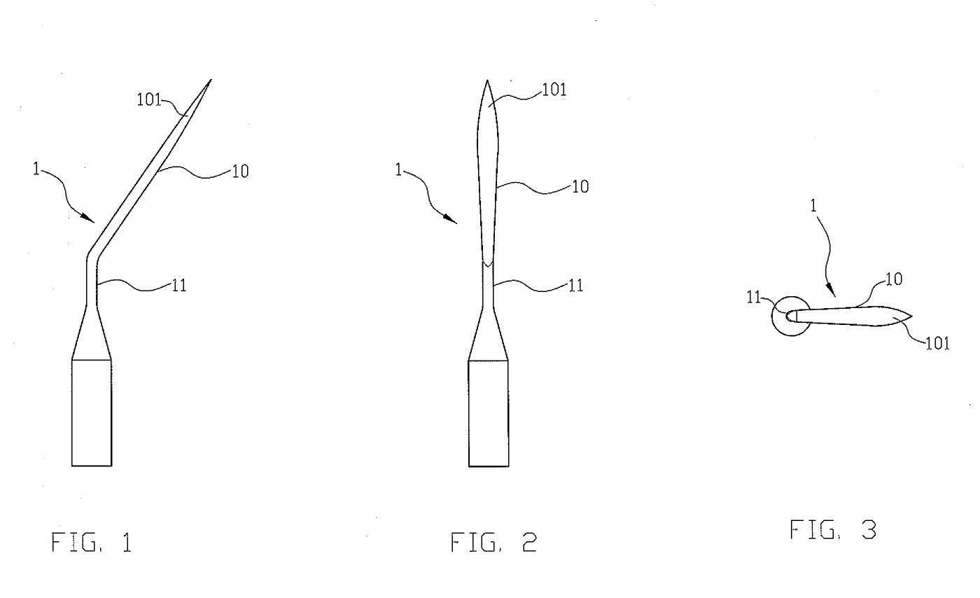

Referring to the drawings and initially to FIGS. 1-3, an extrasonic scaler in accordance with the preferred embodiment of the present invention comprises a triangulate straight scaler 1 having a root portion 11 and a straight flat face 10 extending from the root portion 11 with a determined included angle defined between the root portion 11 and the straight flat face 10. The straight flat face 10 of the triangulate straight scaler 1 has a front end 101 having a triangulate shape.

In operation, the triangulate straight scaler 1 is available for the incisor zone of the upper and lower jaws of the human body, for example, the mesioproximal and distoproximal of the upper and lower lips, the tongue side and the jaw side or the mesioproximal of the wisdom tooth of the lower jaw. Thus, the triangulate straight scaler 1 is used to quickly clear the gums calculus at the lip side and the tongue and jaw side of the incisor zone and to quickly cut the granulation tissue under the gums so as to cut the soft tissue easily and conveniently by design of the straight flat face 10. More specifically, the triangulate straight scaler 1 is more efficiently to drain pus discharge when proceeding incision and drain from gingival.

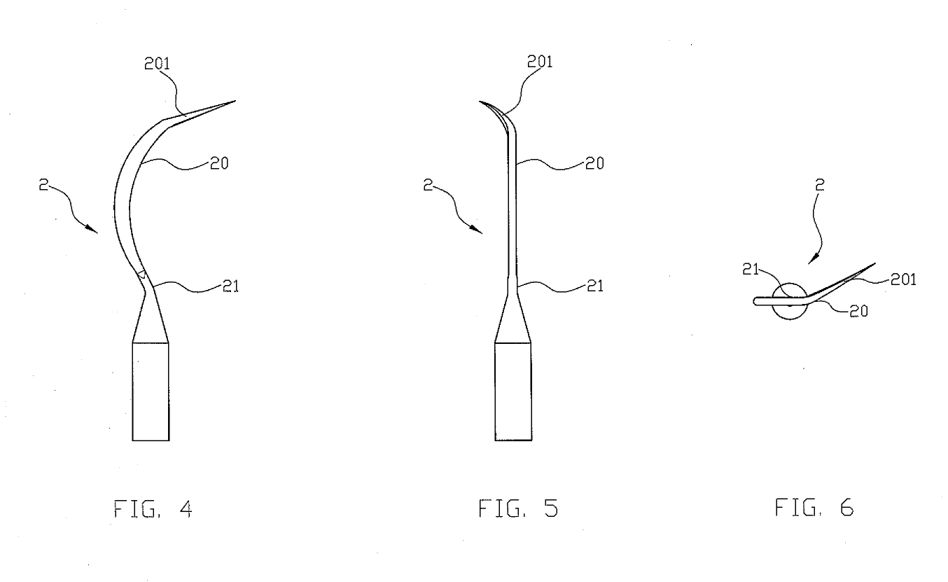

Referring to FIGS. 4-6, the extrasonic scaler further comprises a leftward bent arc-shaped triangulate scaler 2 having a root portion 21 and an arc-shaped flat face 20 extending from the root portion 21 and having a front end 201 bent leftward with a determined included angle defined between the arc-shaped flat face 20 and the front end 201 of the arc-shaped flat face 20. The front end 201 of the arc-shaped flat face 20 of the leftward bent arc-shaped triangulate scaler 2 has a triangulate shape.

In operation, the leftward bent arc-shaped triangulate scaler 2 is available for the molar zone of the upper and lower jaws of the human body, for example, the left jaw side and right cheek side of the upper jaw, the left cheek side and right tongue side of the lower jaw and the root portion at the mesioproximal and distoproximal of the incisor zone. Thus, by design of the arc-shaped flat face 20, the front end 201 of the arc-shaped flat face 20 of the leftward bent arc-shaped triangulate scaler 2 can easily enter and rest on the tooth root surface at the cheek, tongue and jaw sides without hurting the soft tissue so as to quickly clear the gums calculus and the granulation tissue at the cheek, tongue and jaw sides.

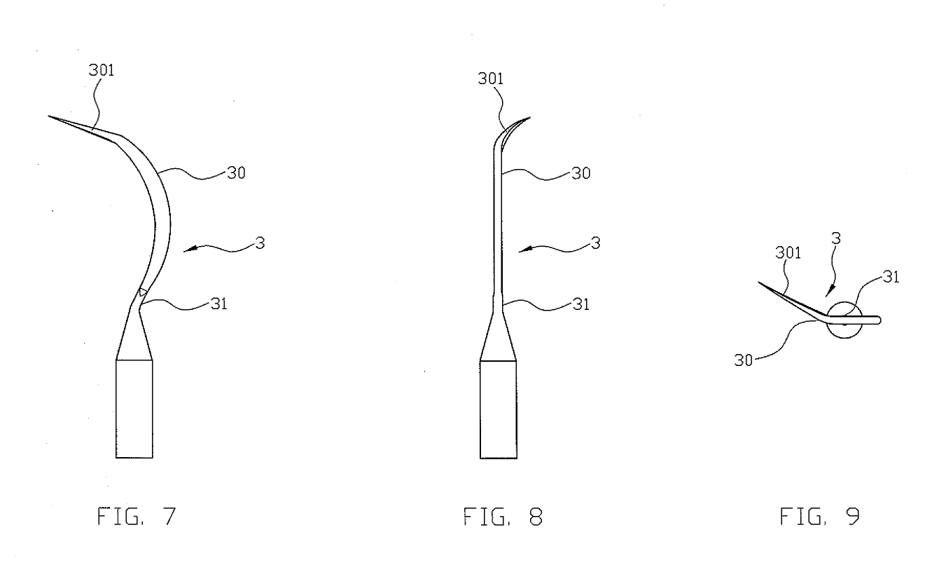

Referring to FIGS. 7-9, the extrasonic scaler further comprises a rightward bent arc-shaped triangulate scaler 3 having a root portion 31 and an arc-shaped flat face 30 extending from the root portion 31 and having a front end 301 bent rightward with a determined included angle defined between the arc-shaped flat face 30 and the front end 301 of the arc-shaped flat face 30. The front end 301 of the arc-shaped flat face 30 of the rightward bent arc-shaped triangulate scaler 3 has a triangulate shape.

In operation, the rightward bent arc-shaped triangulate scaler 3 is available for the molar zone and the incisor zone of the upper and lower jaws of the human body, for example, the left cheek side and right jaw side of the upper jaw, the left tongue side and right cheek side of the lower jaw and the root portion at the mesioproximal and distoproximal of the incisor zone. Thus, by design of the arc-shaped flat face 30, the front end 301 of the arc-shaped flat face 30 of the rightward bent arc-shaped triangulate scaler 3 can easily enter and rest on the tooth root surface at the cheek, tongue and jaw sides without hurting the soft tissue so as to quickly clear the gums calculus and the granulation tissue at the cheek, tongue and jaw sides.

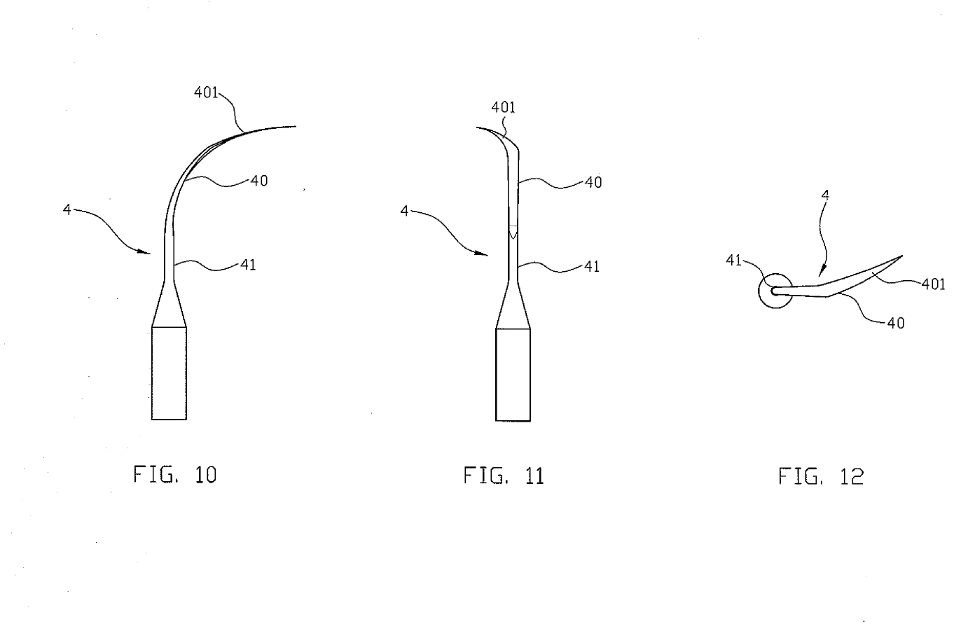

Referring to FIGS. 10-12, the extrasonic scaler further comprises a leftward bent distal-hoe semi-triangulate scaler 4 having a root portion 41 and an arc-shaped distal-hoe flat face 40 extending from the root portion 41 and having a front end 401 bent leftward with a determined included angle defined between the arc-shaped distal-hoe flat face 40 and the front end 401 of the arc-shaped distal-hoe flat face 40. The front end 401 of the arc-shaped distal-hoe flat face 40 of the leftward bent distal-hoe semi-triangulate scaler 4 has a semi-triangulate shape.

In operation, the leftward bent distal-hoe semi-triangulate scaler 4 is available for the molar zone of the upper and lower jaws of the human body, for example, the distoproximal at the left jaw side and right cheek side of the upper jaw and the distoproximal at the left cheek side and right tongue side of the lower jaw. Thus, by design of the arc-shaped distal-hoe flat face 40, the front end 401 of the arc-shaped distal-hoe flat face 40 of the leftward bent distal-hoe semi-triangulate scaler 4 is closer to the tooth root surface without hurting the molar soft tissue so as to provide a comfortable sensation to the patient. In addition, by the arc-shaped design of the arc-shaped distal-hoe flat face 40, the front end 401 of the arc-shaped distal-hoe flat face 40 of the leftward bent distal-hoe semi-triangulate scaler 4 can easily enter the deeper periodontal cells at the molar zone so as to quickly clear the distoproximal gums calculus and granulation tissue.

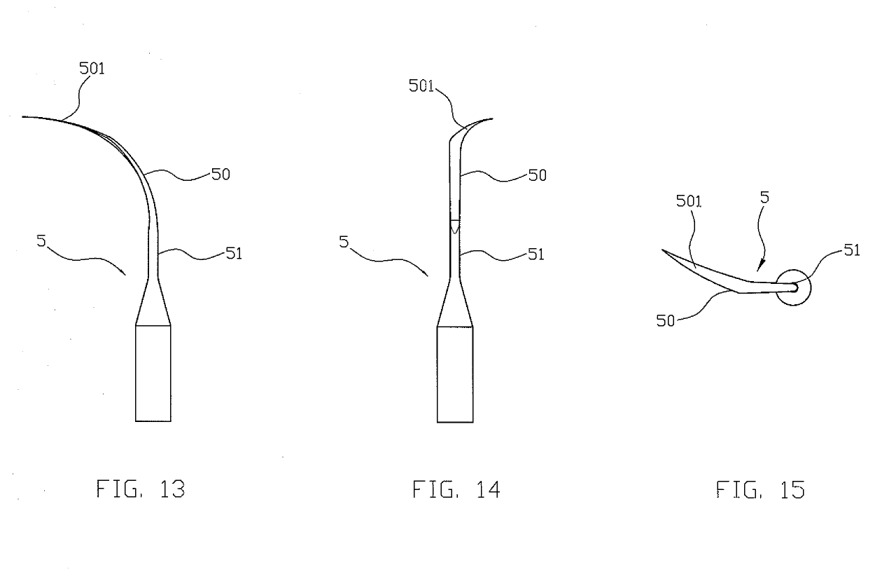

Referring to FIGS. 13-15, the extrasonic scaler further comprises a rightward bent distal-hoe semi-triangulate scaler 5 having a root portion 51 and an arc-shaped distal-hoe flat face 50 extending from the root portion 51 and having a front end 501 bent rightward with a determined included angle defined between the arc-shaped distal-hoe flat face 50 and the front end 501 of the arc-shaped distal-hoe flat face 50. The front end 501 of the arc-shaped distal-hoe flat face 50 of the rightward bent distal-hoe semi-triangulate scaler 5 has a semi-triangulate shape.

In operation, the rightward bent distal-hoe semi-triangulate scaler 5 is available for the molar zone of the upper and lower jaws of the human body, for example, the distoproximal at the left cheek side and right jaw side of the upper jaw and the distoproximal at the left tongue side and right cheek side of the lower jaw. Thus, by design of the arc-shaped distal-hoe flat face 50, the front end 501 of the arc-shaped distal-hoe flat face 50 of the rightward bent distal-hoe semi-triangulate scaler 5 is closer to the tooth root surface without hurting the molar soft tissue so as to provide a comfortable sensation to the patient. In addition, by the arc-shaped design of the arc-shaped distal-hoe flat face 50, the front end 501 of the arc-shaped distal-hoe flat face 50 of the rightward bent distal-hoe semi-triangulate scaler 5 can easily enter the deeper periodontal cells at the molar zone so as to quickly clear the distoproximal gums calculus and granulation tissue.

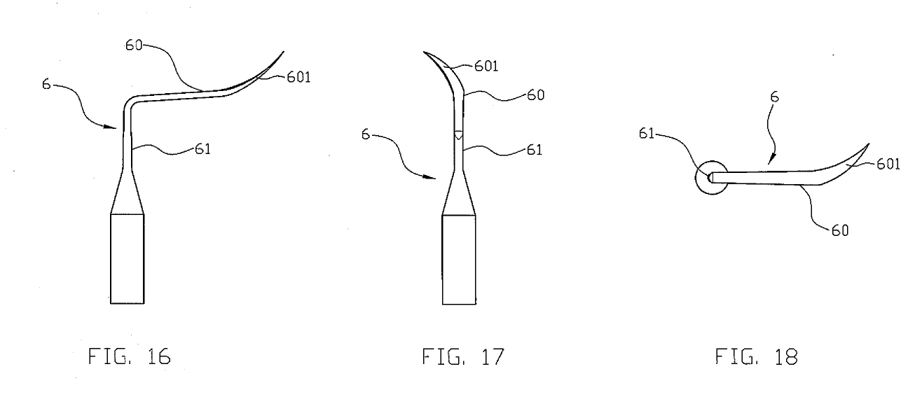

Referring to FIGS. 16-18, the extrasonic scaler further comprises a leftward bent mesial-hoe semi-triangulate scaler 6 having a root portion 61 and an arc-shaped mesial-hoe flat face 60 extending from the root portion 61 with a determined included angle defined between the root portion 61 and the arc-shaped mesial-hoe flat face 60. The arc-shaped mesial-hoe flat face 60 of the leftward bent mesial-hoe semi-triangulate scaler 6 has a front end 601 bent leftward with a determined included angle defined between the arc-shaped mesial-hoe flat face 60 and the front end 601 of the arc-shaped mesial-hoe flat face 60. The front end 601 of the arc-shaped mesial-hoe flat face 60 of the leftward bent mesial-hoe semi-triangulate scaler 6 has a semi-triangulate shape.

In operation, the leftward bent mesial-hoe semi-triangulate scaler 6 is available for the molar zone of the upper and lower jaws of the human body, for example, the mesioproximal at the left jaw side and right cheek side of the upper jaw and the mesioproximal at the left cheek side and right tongue side of the lower jaw. Thus, by design of the arc-shaped mesial-hoe flat face 60, the front end 601 of the arc-shaped mesial-hoe flat face 60 of the leftward bent mesial-hoe semi-triangulate scaler 6 can easily enter and rest on the tooth root surface at the mesioproximal of the tooth without hurting the soft tissue so as to quickly clear the mesioproximal gums calculus and granulation tissue by the pointed, slender and elongated design of the arc-shaped mesial-hoe flat face 60.

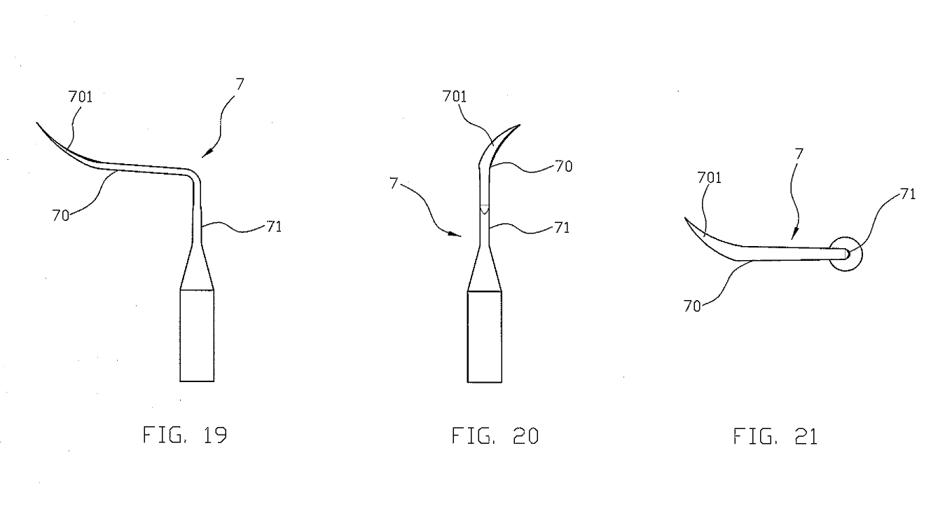

Referring to FIGS. 19-21, the extrasonic scaler further comprises a rightward bent mesial-hoe semi-triangulate scaler 7 having a root portion 71 and an arc-shaped mesial-hoe flat face 70 extending from the root portion 71 with a determined included angle defined between the root portion 71 and the arc-shaped mesial-hoe flat face 70. The arc-shaped mesial-hoe flat face 70 of the rightward bent mesial-hoe semi-triangulate scaler 7 has a front end 701 bent rightward with a determined included angle defined between the arc-shaped mesial-hoe flat face 70 and the front end 701 of the arc-shaped mesial-hoe flat face 70. The front end 701 of the arc-shaped mesial-hoe flat face 70 of the rightward bent mesial-hoe semi-triangulate scaler 7 has a semi-triangulate shape.

In operation, the rightward bent mesial-hoe semi-triangulate scaler 7 is available for the molar zone of the upper and lower jaws of the human body, for example, the mesioproximal at the left cheek side and right jaw side of the upper jaw and the mesioproximal at the left tongue side and right cheek side of the lower jaw. Thus, by design of the arc-shaped mesial-hoe flat face 70, the front end 701 of the arc-shaped mesial-hoe flat face 70 of the rightward bent mesial-hoe semi-triangulate scaler 7 can easily enter and rest on the tooth root surface at the mesioproximal of the tooth without hurting the soft tissue so as to quickly clear the mesioproximal gums calculus and granulation tissue by the pointed, slender and elongated design of the arc-shaped mesial-hoe flat face 70.

Accordingly, the extrasonic scaler comprises seven scalers so that the extrasonic scaler can be operated easily, quickly and conveniently, can easily enter the tooth root surface located in the deeper periodontal cell, can exactly reach the contact point with the tooth root surface, can remove the broken tooth root and the dead periodontal tissue and can be less harmful to the periodontal soft tissue and alveolar bone to provide a comfortable sensation to the patient, thereby enhancing the versatility of the extrasonic scaler. In addition, the extrasonic scaler is helpful to remove the upper and lower calculus of the gums, helpful to the gums shaping, helpful to cutting, incision and drain for gums inflammation, helpful to remove the dead periodontal tissue and the toxins of the tooth root surface, helpful to remnant root canal removal, helpful to replace the traditional elevator to extract the tooth, helpful to reduce harm to the periodontal soft tissue and alveolar bone, helpful to greatly shorten the surgical and treating period and helpful to provide a comfortable sensation to the patient. Further, the extrasonic scaler is designed according to the tooth pattern of the human body so that the extrasonic scaler can reach the deeper surface of the tooth root from various different directions to remedy the oral and periodontal diseases, thereby enhancing the working efficiency.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An extrasonic scaler, comprising:
a triangulate straight scaler having a root portion and a straight flat face extending from the root portion with a determined included angle defined between the root portion and the straight flat face;
a leftward bent arc-shaped triangulate scaler having a root portion and an arc-shaped flat face extending from the root portion and having a front end bent leftward with a determined included angle defined between the arc-shaped flat face and the front end of the arc-shaped flat face;
a rightward bent arc-shaped triangulate scaler having a root portion and an arc-shaped flat face extending from the root portion and having a front end bent rightward with a determined included angle defined between the arc-shaped flat face and the front end of the arc-shaped flat face;
a leftward bent distal-hoe semi-triangulate scaler having a root portion and an arc-shaped distal-hoe flat face extending from the root portion and having a front end bent leftward with a determined included angle defined between the arc-shaped distal-hoe flat face and the front end of the arc-shaped distal-hoe flat face;
a rightward bent distal-hoe semi-triangulate scaler having a root portion and an arc-shaped distal-hoe flat face extending from the root portion and having a front end bent rightward with a determined included angle defined between the arc-shaped distal-hoe flat face and the front end of the arc-shaped distal-hoe flat face;
a leftward bent mesial-hoe semi-triangulate scaler having a root portion and an arc-shaped mesial-hoe flat face extending from the root portion with a determined included angle defined between the root portion and the arc-shaped mesial-hoe flat face;
a rightward bent mesial-hoe semi-triangulate scaler having a root portion and an arc-shaped mesial-hoe flat face extending from the root portion with a determined included angle defined between the root portion and the arc-shaped mesial-hoe flat face.

2. The extrasonic scaler in accordance with claim 1, wherein the straight flat face of the triangulate straight scaler has a front end having a triangulate shape.

3. The extrasonic scaler in accordance with claim 1, wherein the front end of the arc-shaped flat face of the leftward bent arc-shaped triangulate scaler has a triangulate shape.

4. The extrasonic scaler in accordance with claim 1, wherein the front end of the arc-shaped flat face of the rightward bent arc-shaped triangulate scaler has a triangulate shape.

5. The extrasonic scaler in accordance with claim 1, wherein the front end of the arc-shaped distal-hoe flat face of the leftward bent distal-hoe semi-triangulate scaler has a semi-triangulate shape.

6. The extrasonic scaler in accordance with claim 1, wherein the front end of the arc-shaped distal-hoe flat face of the rightward bent distal-hoe semi-triangulate scaler has a semi-triangulate shape.

7. The extrasonic scaler in accordance with claim 1, wherein the arc-shaped mesial-hoe flat face of the leftward bent mesial-hoe semi-triangulate scaler has a front end bent leftward with a determined included angle defined between the arc-shaped mesial-hoe flat face and the front end of the arc-shaped mesial-hoe flat face;

8. The extrasonic scaler in accordance with claim 7, wherein the front end of the arc-shaped mesial-hoe flat face of the leftward bent mesial-hoe semi-triangulate scaler has a semi-triangulate shape.

9. The extrasonic scaler in accordance with claim 1, wherein the arc-shaped mesial-hoe flat face of the rightward bent mesial-hoe semi-triangulate scaler has a front end bent rightward with a determined included angle defined between the arc-shaped mesial-hoe flat face and the front end of the arc-shaped mesial-hoe flat face.

10. The extrasonic scaler in accordance with claim 9, wherein the front end of the arc-shaped mesial-hoe flat face of the rightward bent mesial-hoe semi-triangulate scaler has a semi-triangulate shape.
